(19) United States
(12) Patent Application Publication
(10) Pub. No.: US 2020/0356318 A1
(43) Pub. Date: Nov. 12, 2020

(54) IMAGE FORMING APPARATUS, IMAGE FORMING METHOD, AND PROGRAM

(71) Applicant: Konica Minolta Inc., Tokyo (JP)

(72) Inventors: Dong Wei, Tokyo (JP); Taisuke Akahori, Tokyo (JP)

(21) Appl. No.: 16/865,911

(22) Filed: May 4, 2020

(30) Foreign Application Priority Data
May 8, 2019 (JP) 2019-088317

(51) Int. Cl. G06F 3/12

(52) U.S. Cl. CPC G06F 3/1207; G06F 3/1234; G06F 3/1208

(57) ABSTRACT

An image forming apparatus includes: an image forming apparatus main body that forms an image on a sheet; an image reading device provided downstream of the image forming apparatus main body to read an image formed on the sheet by the image forming apparatus main body; and a hardware processor that controls the image forming apparatus main body and the image reading device, wherein the hardware processor changes, in accordance with a secondary inspection result of secondary inspection in which a user performs visual check, a determination criterion for primary inspection of a read image that is a result of reading an image by the image reading device.

The entire disclosure of Japanese patent Application No. 2019-088317, filed on May 8, 2019, is incorporated herein by reference in its entirety.

### BACKGROUND

### Technological Field

The present disclosure relates to an image forming apparatus, an image forming method, and a program.

### Description of the Related Art

A conventionally proposed technique involves reading an image printed on a sheet transported from an image forming apparatus main body and performing inspection processing for inspecting the quality of the image (for example, see JP2018-036279 A).

However, the conventional technique described in JP 2018-036279 A still requires secondary inspection in which the user visually checks a print piece determined to be normal in inspection processing in order to ensure the quality of the print piece. As a result, a print piece determined to be normal in inspection processing may be determined to be abnormal in secondary inspection. In contrast, a print piece determined to be abnormal in inspection processing may be determined to be normal in secondary inspection. In this manner, determinations can differ between primary inspection by inspection processing and secondary inspection by the user. However, the conventional technique described in JP 2018-036279 A cannot deal with such a case because it does not provide a function for feeding back the difference between primary inspection and secondary inspection to the image forming apparatus for subsequent print jobs.

### SUMMARY

The present disclosure has been made in view of such a situation, and an object thereof is to enable an image forming apparatus to receive feedback on an appropriate determination criterion for subsequent print jobs even when determinations differ between primary inspection and secondary inspection.

To achieve the abovementioned object, according to an aspect of the present invention, an image forming apparatus reflecting one aspect of the present invention comprises: an image forming apparatus main body that forms an image on a sheet; an image reading device provided downstream of the image forming apparatus main body to read an image formed on the sheet by the image forming apparatus main body; and a hardware processor that controls the image forming apparatus main body and the image reading device, wherein the hardware processor changes, in accordance with a secondary inspection result of secondary inspection in which a user performs visual check, a determination criterion for primary inspection of a read image that is a result of reading an image by the image reading device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of an overall configuration of an image forming apparatus according to an embodiment of the present disclosure;

FIG. 2 is a diagram illustrating an example of a functional configuration of the image forming apparatus according to an embodiment of the present disclosure;

FIG. 3 is a diagram illustrating an example of a user interface for the secondary inspection mode that is displayed on a display, according to an embodiment of the present disclosure;

FIG. 4 is a diagram illustrating an example of a user interface for two modes included in the secondary inspection mode that is displayed on the display, according to an embodiment of the present disclosure;

FIG. 5 is a diagram illustrating an example of a user interface that is displayed on the display in response to the secondary inspection NG mode included in the secondary inspection mode being selected, according to an embodiment of the present disclosure;

FIG. 6 is a diagram illustrating an example of a user interface that is displayed on the display, in which an NG area is selected in the secondary inspection NG mode, according to an embodiment of the present disclosure;

FIG. 7 is a diagram illustrating an example of a user interface that is displayed on the display, in which a change in the determination level is received while an NG area is selected in the secondary inspection NG mode, according to an embodiment of the present disclosure;

FIG. 8 is a diagram illustrating an example of a user interface that is displayed on the display, in which a change in the determination level is automatically determined while an NG area is selected in the secondary inspection NG mode, according to an embodiment of the present disclosure;

FIG. 9 is a diagram illustrating an example of a user interface that is displayed on the display, in which the determination level is automatically adjusted in the secondary inspection NG mode, according to an embodiment of the present disclosure;

FIG. 10 is a diagram illustrating an example of a user interface that is displayed on the display in response to the secondary inspection OK mode included in the secondary inspection mode being selected, according to an embodiment of the present disclosure;

FIG. 11 is a diagram illustrating an example of a user interface that is displayed on the display, in which an area that should be regarded as OK is selected from among the determined NG areas in the secondary inspection OK mode, according to an embodiment of the present disclosure;

FIG. 12 is a diagram illustrating an example of a user interface that is displayed on the display, in which an NG area is selected in the secondary inspection OK mode, according to an embodiment of the present disclosure;

FIG. 13 is a diagram illustrating an example of a user interface that is displayed on the display, in which a job to which the secondary inspection mode is applied is selected, according to an embodiment of the present disclosure;

FIG. 14 is a flowchart for explaining a control example of the image forming apparatus according to an embodiment of the present disclosure;

FIG. 15 is a flowchart illustrating the secondary inspection NG mode process according to an embodiment of the present disclosure;

FIG. 16 is a flowchart illustrating the secondary inspection OK mode process according to an embodiment of the present disclosure;

FIG. 17 is a flowchart illustrating a first modification of the secondary inspection NG mode process according to an embodiment of the present disclosure;

FIG. 18 is a flowchart illustrating a second modification of the secondary inspection NG mode process according to an embodiment of the present disclosure;

FIG. 19 is a flowchart illustrating a third modification of the secondary inspection OK mode process according to an embodiment of the present disclosure; and

FIG. 20 is a flowchart illustrating a fourth modification of the secondary inspection NG mode process according to an embodiment of the present disclosure.

### DETAILED DESCRIPTION OF EMBODIMENTS

Hereinafter, one or more embodiments of the present invention will be described with reference to the drawings. However, the scope of the invention is not limited to the disclosed embodiments.

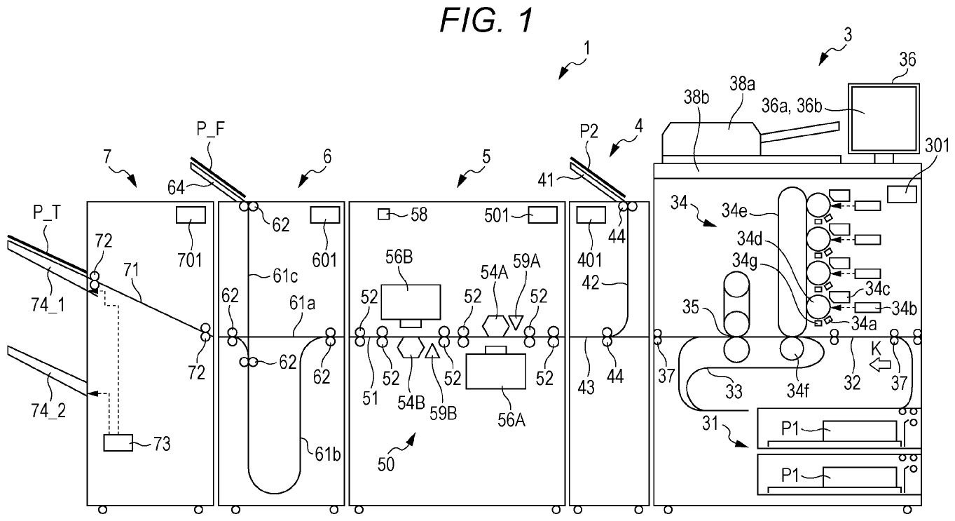

FIG. 1 is a diagram illustrating an example of an overall configuration of an image forming apparatus 1 according to an embodiment of the present disclosure. The image forming apparatus 1 includes an image forming apparatus main body 3, a paper inserter 4, an image reading device 5, a paper discharging device 6, and a paper discharging device 7. The image forming apparatus main body 3, which will be described in more detail later, includes at least an image former 34. That is, the image forming apparatus 1 includes the image former 34. The paper inserter 4, the image reading device 5, the paper discharging device 6, and the paper discharging device 7 are placed downstream of the image forming apparatus main body 3. The paper inserter 4, which will be described in more detail later, includes at least a sheet feed path 42. The image reading device 5, which will be described in more detail later, includes at least an inspector 50. The inspector 50 inspects a sheet P1 transported from the image former 34 or a print piece P2 transported from the sheet feed path 42. The sheet P1 or the print piece P2 is an object to be inspected by the inspector 50.

The image forming apparatus main body 3 includes the image former 34 that forms an image on the sheet P1 placed in a sheet feeder 31. The sheet P1 is a flat sheet such as a cut sheet, for example. The image forming apparatus main body 3 includes a setter 36 at an upper part. The setter 36 includes a display 36a and an operation interface 36b. The setter 36 receives a user operation via the operation interface 36b and displays information on the display 36a. For example, the setter 36 receives inspection processing and displays the result of inspection.

In the setter 36, for example, the display 36a is formed of a liquid crystal display, and the operation interface 36b is configured as a touch panel display formed of a touch panel. On the image forming apparatus main body 3, an automatic document feeding device 38a and a document image scanning device 38b for automatically reading a document are provided. The document image scanning device 38b can read an image via the platen glass. The document image scanning device 38b reads an image of a document, for example, which is used by the image former 34 to form an image. The image former 34 is provided on a transport path 32. The sheet P1 placed in the sheet feeder 31 is fed and transported toward the image former 34 through the transport path 32 along the transporting direction K by a plurality of transport rollers 37. The image former 34 includes a photoconductor 34d prepared for each color such as cyan, magenta, yellow, and black. An electrifying device 34a, an exposure device 34b, and a developing device 34c are provided near each photoconductor 34d.

The surface of the photoconductor 34d electrified by the electrifying device 34a is exposed to an image by the exposure device 34b based on the document image data of the print job, and an electrostatic latent image is formed. The electrostatic latent image is developed by the developing device 34c to become a toner image. The toner image is transferred to an intermediate transfer belt 34e. The toner image transferred to the intermediate transfer belt 34e is pressed and transferred to the sheet P1 by a secondary transfer roller 34f. The toner image pressed and transferred by the secondary transfer roller 34f is heated and pressurized by a fixer 35 to be fixed on the sheet P1. As a result, an image is formed on the sheet P1 in the image forming apparatus main body 3. That is, the image former 34 transfers an image to the sheet P1 by forming an image using an electrophotographic process. Note that a drum cleaning device 34g is provided near the photoconductor 34d. The drum cleaning device 34g removes residual toner remaining on the intermediate transfer belt 34e. Note that images can be formed on both surfaces of the sheet P1. In this case, the sheet P1 having an image formed on one surface is transported through a circulation path 33 to return to the image former 34, so that another image can be formed on the other surface. A controller 301 includes a CPU, a ROM, a RAM, an I/O interface, and the like (not illustrated). The CPU reads a program from the ROM in accordance with processing details, develops it in the RAM, and cooperates with the developed program to control the operation of the image forming apparatus main body 3.

The paper inserter 4 is placed downstream of the image forming apparatus main body 3 and upstream of the image reading device 5, and can feed the print piece P2 placed on a sheet feed tray 41 to the image reading device 5 without involving the image forming apparatus main body 3. The paper inserter 4 includes the sheet feed tray 41 at an upper part, and internally includes the sheet feed path 42, a transport path 43, a plurality of transport rollers 44, and a controller 401. The sheet feed path 42 is provided to bypass the image former 34, and transports the print piece P2 placed on the sheet feed tray 41 to the transport path 43 by the transport rollers 44. The controller 401 includes a CPU, a ROM, a RAM, an I/O interface, and the like (not illustrated). The CPU reads a program from the ROM in accordance with processing details, develops it in the RAM, and cooperates with the developed program to control the operation of the paper inserter 4.

The image reading device 5 includes the inspector 50, a transport path 51, a plurality of transport rollers 52, a first temperature detector 58, a second temperature detector 59A, a second temperature detector 59B, and a controller 501. The inspector 50 includes a background member 54A, a background member 54B, a first scanner 56A, and a second scanner 56B. Note that the background member 54A and the background member 54B may be collectively referred to as the background member 54. The first scanner 56A and the second scanner 56B are collectively referred to as the scanner 56. The second temperature detector 59A and the second temperature detector 59B are collectively referred to as the second temperature detector 59. The transport path 51 is a path through which the sheet P1 or the print piece P2 passes. The transport rollers 52 transport the sheet P1 or the print piece P2. The first scanner 56A is placed at a position where the back surface of the sheet P1 or the print piece P2 is read, and reads the back surface image of an object. The result of reading by the first scanner 56A may be used, for example, for checking whether the front and back images formed on the sheet P1 or printed on the print piece P2 are in alignment or checking the presence or absence of an unexpected image. The second scanner 56B is placed at a position where the front surface of the sheet P1 or the print piece P2 is read, and reads the front surface image of an object. Specifically, the second scanner 56B reads an image formed on the sheet P1 or an image printed on the print piece P2. While the sheet P1 or the print piece P2 is being transported, the second scanner 56B reads the color of an image formed on the sheet P1 or an image printed on the print piece P2 along the orthogonal direction that is orthogonal to the traveling direction of the sheet P1 or the print piece P2, that is, along the main scanning direction.

The controller 501 includes a CPU, a ROM, a RAM, an I/O interface, and the like (not illustrated). The CPU reads a program from the ROM in accordance with processing details, develops it in the RAM, and cooperates with the developed program to control the operation of the image reading device 5. The controller 501 controls the inspector 50 in accordance with the operation mode in which set processing is executed. When the operation mode is the first mode, the controller 501 causes the inspector 50 to detect an image formed on the sheet P1 transported from the image former 34 as an object. When the operation mode is the second mode, the controller 501 causes the inspector 50 to detect an image printed on the print piece P2 transported from the sheet feed path 42 as an object. When the operation mode is the first mode, the controller 501 adjusts the transport speed at which the object is transported to the inspector 50 to the transport speed of the sheet P1 by the image former 34. When the operation mode is the second mode, the controller 501 makes the transport speed at which the object is transported to the inspector 50 slower than the transport speed of the sheet P1 by the image former 34. For example, the controller 501 can control the transport speed at which the object is transported simply by performing control in a manner that makes the rotation speed of the transport rollers 52 lower than the rotation speed of the transport rollers 37.

The inspector 50 inspects an object based on inspection image data corresponding to an image on the object read by the scanner 56 and correct image data that serve as an inspection criterion. Different types of correct image data are used depending on whether the operation mode is the first mode or the second mode. When the operation mode is the first mode, the controller 501 causes the scanner 56 to read the first image of the images formed on the sheet P1 by the image former 34 based on the document image data, and designates this first image as correct image data. When the operation mode is the second mode, the controller 501 designates the document image data as correct image data. The document image data are extracted from the print job. Information for identifying an image to be formed on the sheet P1 is defined by the document image data. Therefore, the controller 501 causes the scanner 56 to execute either two-side or one-side reading operation on the object based on the document image data. Specifically, for execution of two-side reading operation on the object, the controller 501 drives both the first scanner 56A and the second scanner 56B. For execution of one-side reading operation on the object, the controller 501 drives either the first scanner 56A or the second scanner 56B.

When an object is inspected by the inspector 50, if the temperature difference between room temperature and the temperature of the image read by the scanner 56 is large, the color varies greatly due to the thermochromism phenomenon. Therefore, when the thermochromism phenomenon is expected, it is preferable to perform thermochromism correction. Specifically, the controller 501 performs thermochromism correction on inspection image data read by the scanner 56 based on the ambient temperature detected by the first temperature detector 58 that detects the ambient temperature of the image forming apparatus 1 and the surface temperature detected by the second temperature detector 59 that detects the surface temperature of an object. More specifically, in a case where the difference between the ambient temperature and the surface temperature exceeds a preset temperature range, the controller 501 determines the amount of thermochromism correction. Note that the sheet P1 transported from the image former 34 is exposed to heat through the fixer 35. Therefore, thermochromism correction is required. That is, when the operation mode is the first mode, the controller 501 performs thermochromism correction in accordance with the surface temperature.

If inspected objects are placed in different locations depending on the result of inspection processing, workability for the user is improved. Specifically, it is preferable that different discharge destinations for objects inspected by the inspector 50 be provided depending on whether the operation mode is the first mode or the second mode. Below is a detailed description of discharge destinations. The paper discharging device 6 includes transport paths 61a to 61c, a plurality of transport rollers 62, a purge tray 64, and a controller 601. The transport paths 61a to 61c may be collectively referred to as the transport path 61. The purge tray 64 is provided above the paper discharging device 6 and serves as a discharge destination for the sheet P1 or print piece P2 transported by the transport path 61c. The transport path 61a transports the sheet P1 or print piece P2 transported from the image reading device 5 to the paper discharging device 7 with the aid of the transport rollers 62 driven. The transport path 61b transports the sheet P1 or print piece P2 transported from the image reading device 5 to the transport path 61c with the aid of the transport rollers 62 driven. The transport path 61c transports the sheet P1 or print piece P2 transported from the transport path 61b to the purge tray 64 with the aid of the transport rollers 62 driven. The controller 601 includes a CPU, a ROM, a RAM, an I/O interface, and the like (not illustrated). The CPU reads a program from the ROM in accordance with processing details, develops it in the RAM, and cooperates with the developed program to control the operation of the paper discharging device 6.

The paper discharging device 7 includes a paper discharging path 71, a plurality of paper discharging rollers 72, a driver 73, a main tray 74_1, a main tray 74_2, and a controller 701. The main tray 74_1 and the main tray 74_2 may be collectively referred to as the main tray 74. The main tray 74_1 and the main tray 74_2 are vertically movable by the driver 73, and serve as discharge destinations for the sheet P1 or print piece P2 transported by the paper discharging path 71. The paper discharging path 71 discharges the sheet P1 or print piece P2 transported from the paper discharging device 6 to the main tray 74 with the aid of the paper discharging rollers 72 driven. The controller 701 includes a CPU, a ROM, a RAM, an I/O interface, and the like (not illustrated). The CPU reads a program from the ROM in accordance with processing details, develops it in the RAM, and cooperates with the developed program to control the operation of the paper discharging device 7.

In other words, the paper discharging device 6 and the paper discharging device 7 form a plurality of discharge destinations for objects inspected by the inspector 50. Therefore, the inspector 50 causes objects determined to be waste paper P_F as the result of inspection to be discharged to one or more of the plurality of discharge destinations. The inspector 50 causes objects determined to be normal paper P T as the result of inspection to be discharged to one or more of the other discharge destinations. For example, the waste paper P_F can be discharged to the purge tray 64. The normal paper P T can be discharged to the main tray 74.

Note that each of the controller 201, the controller 301, the controller 401, the controller 501, the controller 601, and the controller 701 controls the operation of the image forming apparatus 1. Therefore, the inspection processing which will be described in detail below may be performed under the control of not only the controller 501 as described above but also any of the controller 201, the controller 301, the controller 401, the controller 601, and the controller 701.

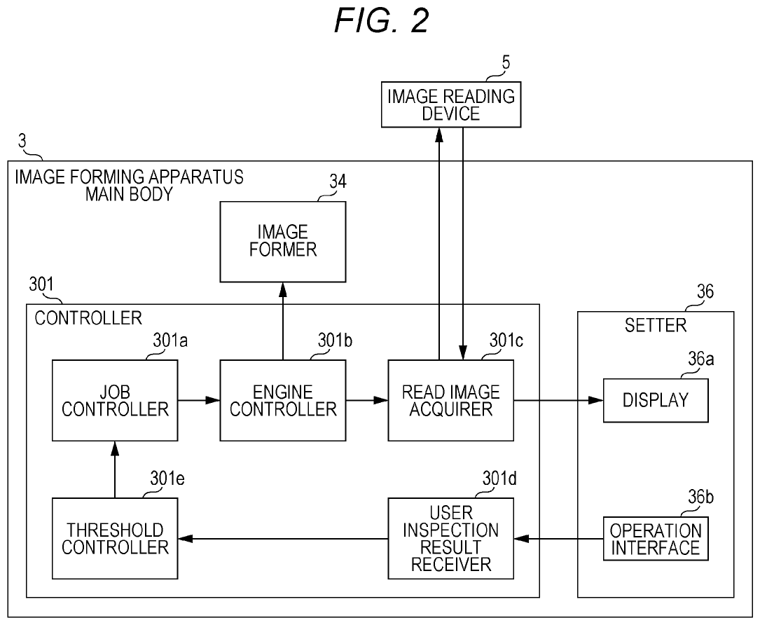

FIG. 2 is a diagram illustrating an example of a functional configuration of the image forming apparatus 1 according to an embodiment of the present disclosure. As illustrated in FIG. 2, the controller 301 implements each of the functions of a job controller 301a, an engine controller 301b, a read image acquirer 301c, a user inspection result receiver 301d, and a threshold controller 301e. The job controller 301a sets a print job on which the secondary inspection mode is executed, and notifies the engine controller 301b. The engine controller 301b starts engine control, that is, control of the image former 34, in accordance with the print job provided by the job controller 301a. The read image acquirer 301c causes the image reading device 5 to read the print piece P2 for secondary inspection taken in from the paper inserter 4, and causes the display 36a to display the read image as the result of reading the print piece P2 by the image reading device 5. The user inspection result receiver 301d receives an operation instruction for the operation interface 36b and notifies the threshold controller 301e. The threshold controller 301e changes the determination criterion for primary inspection based on the operation instruction provided by the user inspection result receiver 301d.

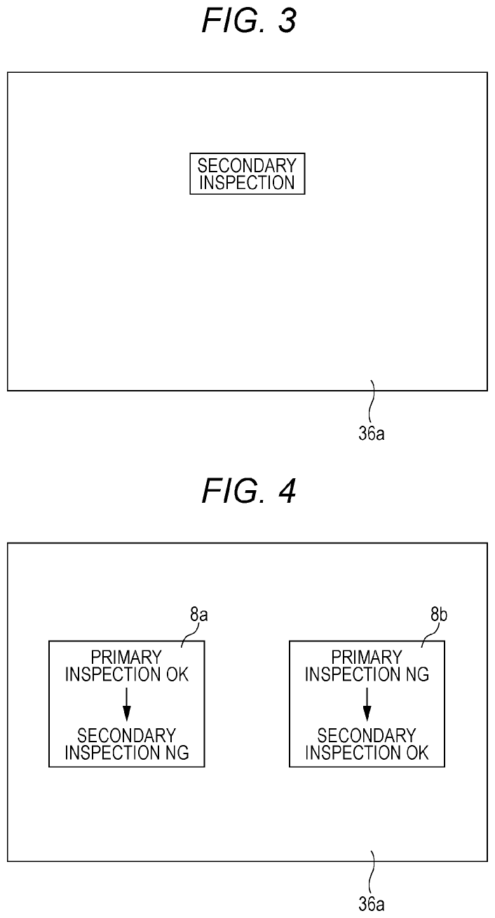

FIG. 3 is a diagram illustrating an example of a user interface for the secondary inspection mode that is displayed on the display 36a, according to an embodiment of the present disclosure. The secondary inspection mode is started in response to an operation instruction for the operation interface 36b. FIG. 4 is a diagram illustrating an example of a user interface for two modes included in the secondary inspection mode that is displayed on the display 36a, according to an embodiment of the present disclosure. In the following drawings, NG means that the inspection result is abnormal, and OK means that the inspection result is normal. The inspection result as used herein is a primary inspection result or a secondary inspection result. Once a secondary inspection NG mode selector 8a is pressed, a mode for objects determined to be normal in primary inspection but determined to be abnormal in secondary inspection is executed, which is referred to as the secondary inspection NG mode. Once a secondary inspection OK mode selector 8b is pressed, a mode for objects determined to be abnormal in primary inspection but determined to be normal in secondary inspection is executed, which is referred to as the secondary inspection OK mode.

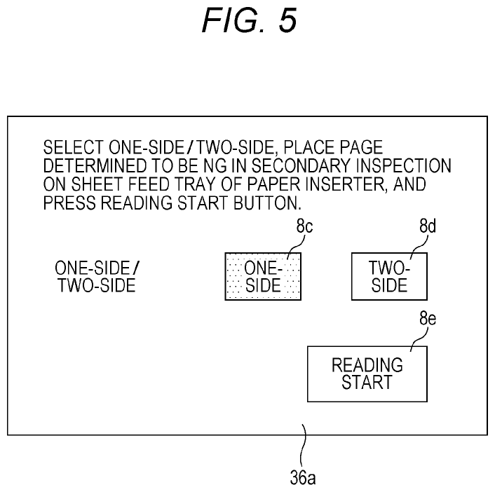

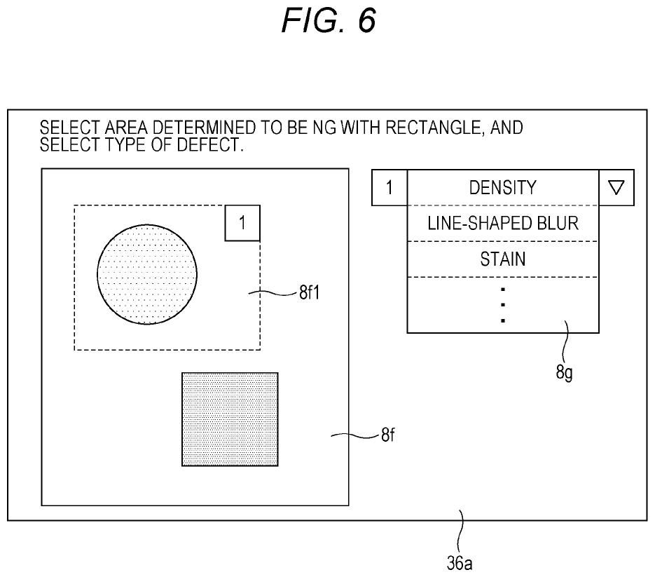

Next, a process that is performed when the secondary inspection NG mode selector 8a is pressed will be described with reference to FIGS. 5 to 9. FIG. 5 is a diagram illustrating an example of a user interface that is displayed on the display 36a in response to the secondary inspection NG mode included in the secondary inspection mode being selected, according to an embodiment of the present disclosure. After either a one-side selector 8c or a two-side selector 8d is selected, a reading start selector 8e is selected. The reading start selector 8e functions as a reading start button. FIG. 6 is a diagram illustrating an example of a user interface that is displayed on the display 36a, in which an NG area is selected in the secondary inspection NG mode, according to an embodiment of the present disclosure. In a read image display area 8f, a selection area 8f1 is selected as an area determined to be NG, and the type of defect contributing to the determined abnormality of the image can be selected from a defect type selector 8g.

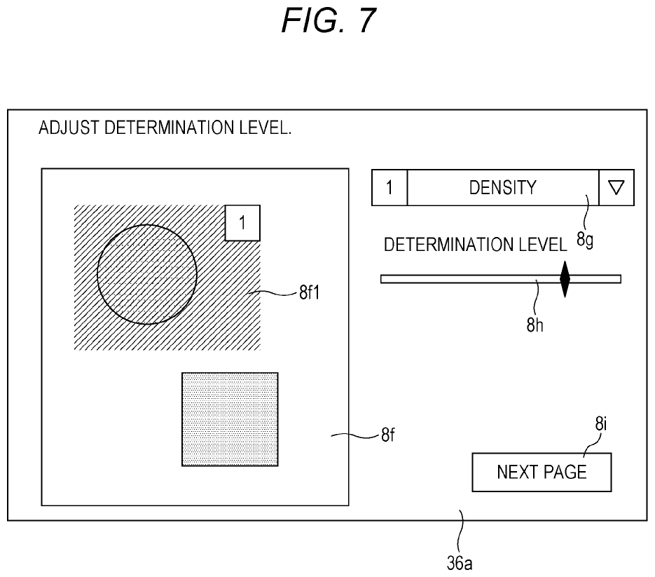

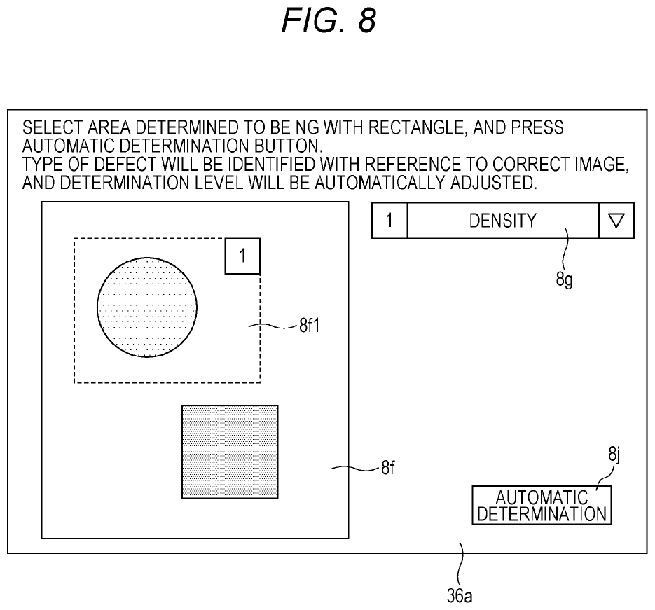

FIG. 7 is a diagram illustrating an example of a user interface that is displayed on the display 36a, in which a change in the determination level is received while an NG area is selected in the secondary inspection NG mode, according to an embodiment of the present disclosure. For example, density is selected as the type of defect, and the determination level of density is adjusted by a determination level adjuster 8h. As a result, the selection area 8f1 is displayed in a manner different from the normal one, e.g. hatching. Consequently, the user can be notified that the determination level has become appropriate. Once a display screen next page selector 8i is pressed, the screen illustrated in FIG. 8 appears.

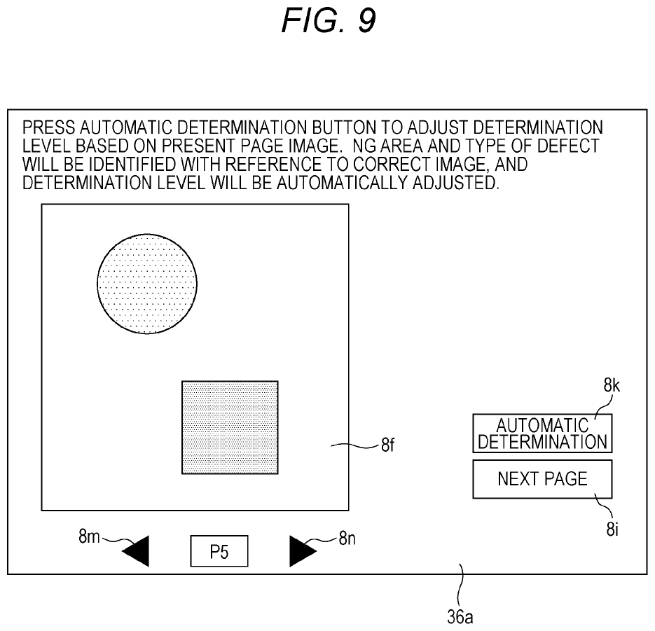

FIG. 8 is a diagram illustrating an example of a user interface that is displayed on the display 36a, in which a change in the determination level is automatically determined while an NG area is selected in the secondary inspection NG mode, according to an embodiment of the present disclosure. When an automatic determination selector 8j is selected, the determination level is automatically adjusted. The determination level can also be adjusted by specifying a page. FIG. 9 is a diagram illustrating an example of a user interface that is displayed on the display 36a, in which the determination level is automatically adjusted in the secondary inspection NG mode, according to an embodiment of the present disclosure. In the example of FIG. 9, the read image of a page specified by a previous page searcher 8m and a next page searcher 8n is displayed, and an automatic determination selector 8k is pressed to compare the read image (read image data) and the correct image (correct image data). Then, an abnormal area and the type of defect are identified, and the determination level is automatically adjusted.

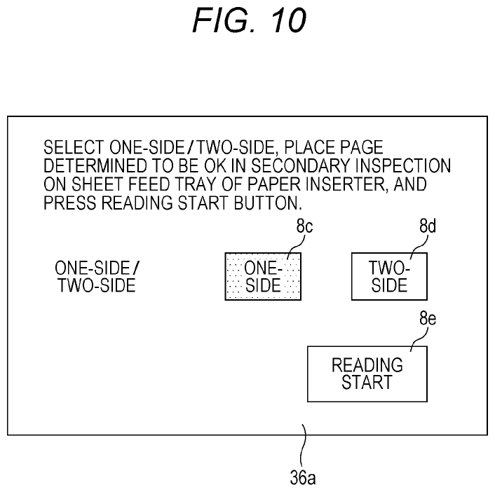

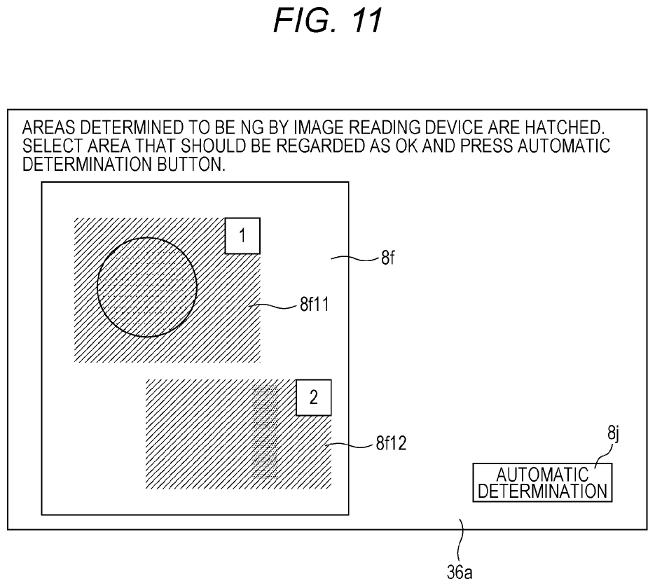

Next, a process that is performed when the secondary inspection OK mode selector 8b is pressed will be described with reference to FIGS. 10 and 11. FIG. 10 is a diagram illustrating an example of a user interface that is displayed on the display 36a in response to the secondary inspection OK mode included in the secondary inspection mode being selected, according to an embodiment of the present disclosure. FIG. 11 is a diagram illustrating an example of a user interface that is displayed on the display 36a, in which an area that should be regarded as OK is selected from among the determined NG areas in the secondary inspection OK mode, according to an embodiment of the present disclosure. As illustrated in FIG. 11, a selection area 8f11 and a selection area 8f12 are hatched as areas determined to be abnormal by the image reading device 5, and an area that should be regarded as OK can be selected.

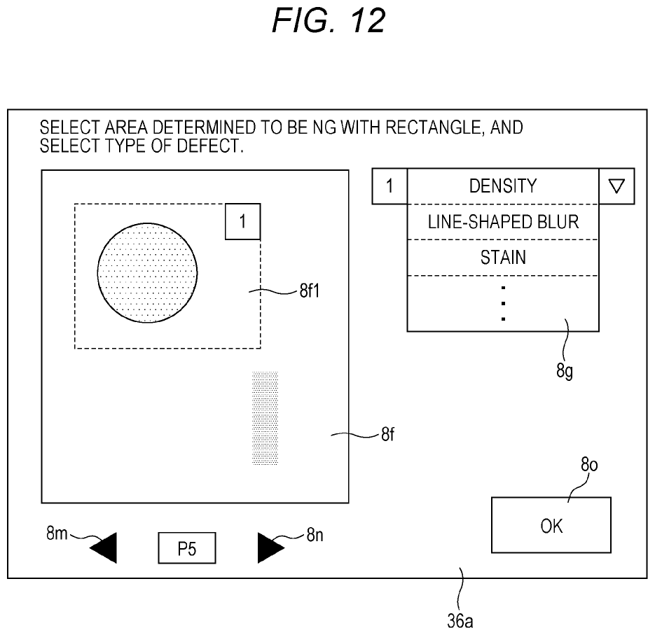

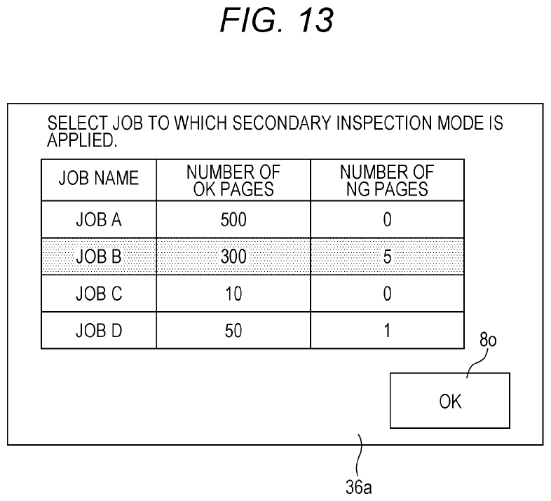

FIG. 12 is a diagram illustrating an example of a user interface that is displayed on the display 36a, in which an NG area is selected in the secondary inspection OK mode, according to an embodiment of the present disclosure. Here, by specifying a page, the read image read by the image reading device 5 during image formation can be acquired. Note that OK on an OK selector 8o does not mean normal, but means acknowledgment. FIG. 13 is a diagram illustrating an example of a user interface that is displayed on the display 36a, in which a job to which the secondary inspection mode is applied is selected, according to an embodiment of the present disclosure. In FIG. 13, a job means a print job. As illustrated in FIG. 13, a print job to which the secondary inspection mode is applied can be selected from among a plurality of print jobs.

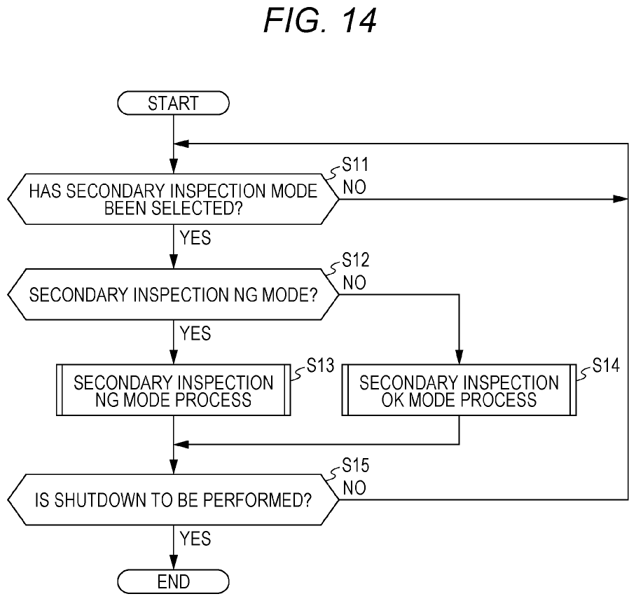

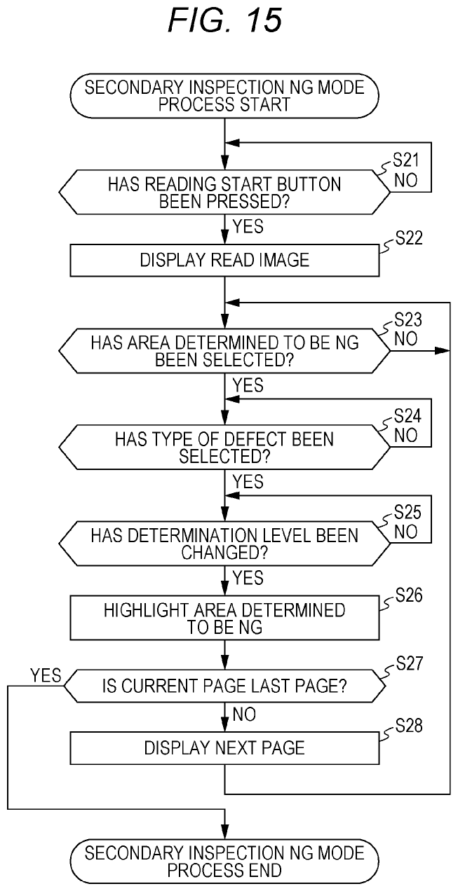

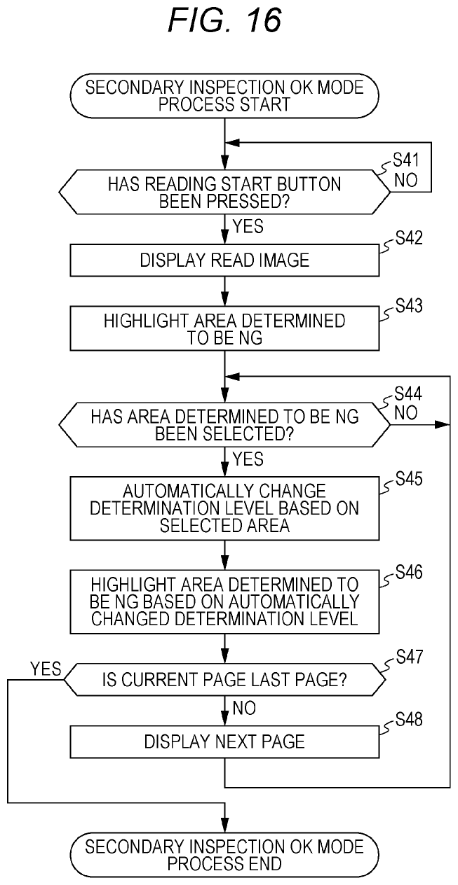

FIG. 14 is a flowchart for explaining a control example of the image forming apparatus 1 according to an embodiment of the present disclosure. In step S11, the controller 301 determines whether the secondary inspection mode has been selected. When determining that the secondary inspection mode has been selected (step S11; Y), the controller 301 proceeds to step S12. When determining that the secondary inspection mode has not been selected (step S11; N), the controller 301 continues step S11. In step S12, the controller 301 determines whether the mode is the secondary inspection NG mode. When determining that the mode is the secondary inspection NG mode (step S12; Y), the controller 301 proceeds to step S13. In step S13, the controller 301 executes the secondary inspection NG mode process, and proceeds to step S15. Note that the secondary inspection NG mode process will be described in more detail with reference to FIG. 15. When determining that the mode is not the secondary inspection NG mode (step S12; N), the controller 301 proceeds to step S14. In step S14, the controller 301 executes the secondary inspection OK mode process, and proceeds to step S15. Note that the secondary inspection OK mode process will be described in more detail with reference to FIG. 16. In step S15, the controller 301 determines whether a shutdown is to be performed. When determining that a shutdown is to be performed (step S15; Y), the controller 301 ends the process. When determining that a shutdown is not to be performed (step S15; N), the controller 301 returns to step S11.

FIG. 15 is a flowchart illustrating the secondary inspection NG mode process according to an embodiment of the present disclosure. In step S21, the controller 301 determines whether the reading start button has been pressed. When determining that the reading start button has been pressed (step S21; Y), the controller 301 proceeds to step S22. When determining that the reading start button has not been pressed (step S21; N), the controller 301 continues step S21. In step S22, the controller 301 displays the read image, and proceeds to step S23. In step S23, the controller 301 determines whether an area determined to be NG has been selected. When determining that an area determined to be NG has been selected (step S23; Y), the controller 301 proceeds to step S24. When determining that an area determined to be NG has not been selected (step S23; N), the controller 301 continues step S23. In step S24, the controller 301 determines whether the type of defect has been selected. When determining that the type of defect has been selected (step S24; Y), the controller 301 proceeds to step S25. When determining that the type of defect has not been selected (step S24; N), the controller 301 continues step S24. In step S25, the controller 301 determines whether the determination level has been changed. When determining that the determination level has been changed (step S25; Y), the controller 301 proceeds to step S26. When determining that the determination level has not been changed (step S25; N), the controller 301 continues step S25. In step S26, the controller 301 highlights the area determined to be NG, and proceeds to step S27. In the above example, hatching is used as a way of highlighting, but the present invention is not limited thereto. For example, a different display color may be used as a way of highlighting. In step S27, the controller 301 determines whether the current page is the last page. When determining that the current page is the last page (step S27; Y), the controller 301 ends the secondary inspection NG mode process. When determining that the current page is not the last page (step S27; N), the controller 301 proceeds to step S28. In step S28, the controller 301 displays the next page, and returns to step S23.

FIG. 16 is a flowchart illustrating the secondary inspection OK mode process according to an embodiment of the present disclosure. Note that steps S41, S42, S47, and S48 are respectively the same as steps S21, S22, S27, and S28, and a description thereof will be omitted. In step S43, the controller 301 highlights an area determined to be NG, and proceeds to step S44. In step S44, the controller 301 determines whether an area determined to be NG has been selected. When determining that an area determined to be NG has been selected (step S44; Y), the controller 301 proceeds to step S45. When determining that an area determined to be NG has not been selected (step S44; N), the controller 301 continues step S44. In step S45, the controller 301 automatically changes the determination level based on the selected area, and proceeds to step S46. In step S46, the controller 301 highlights the area determined to be NG based on the automatically changed determination level, and proceeds to step S47.

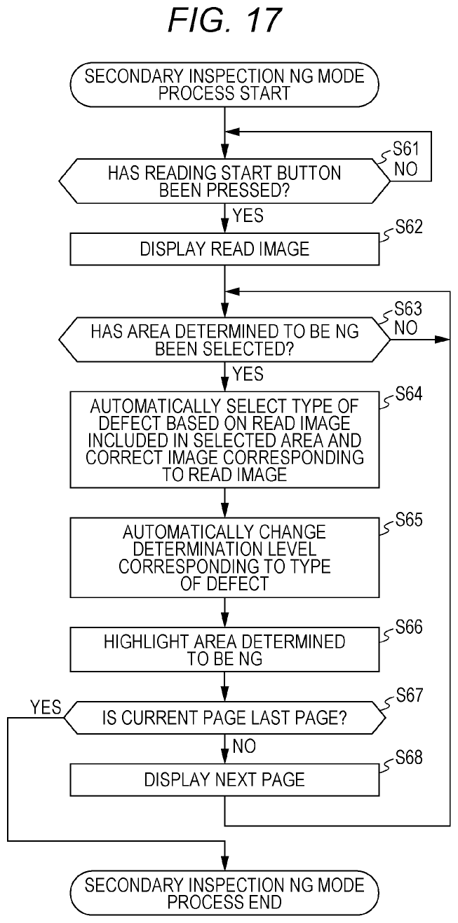

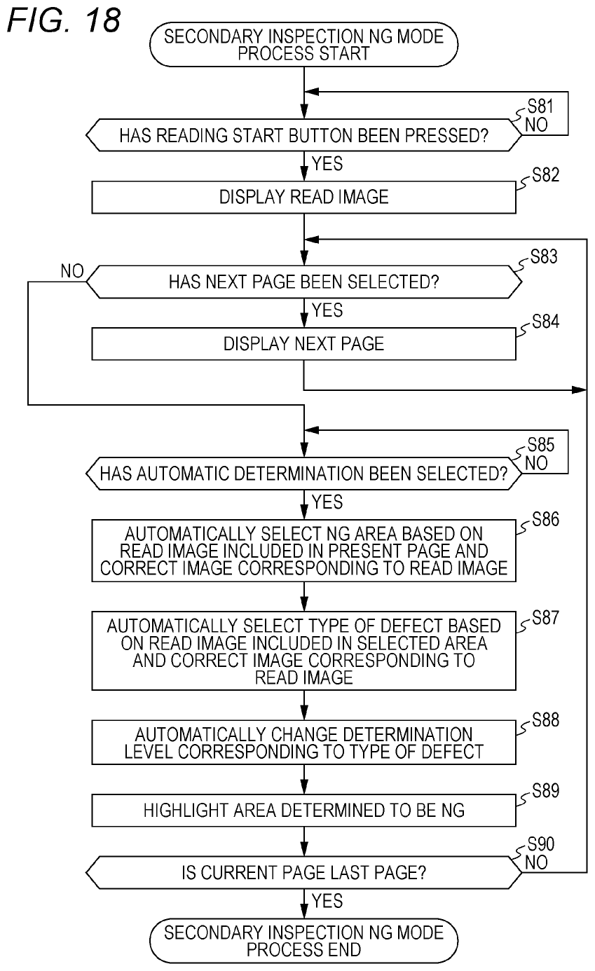

FIG. 17 is a flowchart illustrating a first modification of the secondary inspection NG mode process according to an embodiment of the present disclosure. Note that steps S61, S62, and S66 to S68 are respectively the same as steps S21, S22, and S26 to S28, and a description thereof will be omitted. In step S63, the controller 301 determines whether an area determined to be NG has been selected. When determining that an area determined to be NG has been selected (step S63; Y), the controller 301 proceeds to step S64. When determining that an area determined to be NG has not been selected (step S63; N), the controller 301 continues step S63. In step S64, the controller 301 automatically selects the type of defect based on the read image included in the selected area and the correct image corresponding to the read image, and proceeds to step S65. In step S65, the controller 301 automatically changes the determination level corresponding to the type of defect, and proceeds to step S66.

For example, if the print job is composed of 100 pages, the correct image corresponding to the currently displayed read image can be acquired by extracting the correct image having the highest similarity to the read image from the correct images for the 100 pages. After the automatic determination, the user can be notified that the determination level has become appropriate by highlighting with hatching or the like as illustrated in FIG. 7. Note that the automatically determined determination level may be manually adjusted.

FIG. 18 is a flowchart illustrating a second modification of the secondary inspection NG mode process according to an embodiment of the present disclosure. FIG. 18 is a process of automatically determining all of an NG area, the type of defect, and the determination level. Note that steps S81 and S82 are respectively the same as steps S21 and S22, and a description thereof will be omitted. In step S83, the controller 301 determines whether the next page has been selected. When determining that the next page has been selected (step S83; Y), the controller 301 proceeds to step S84. When determining that the next page has not been selected (step S83; N), the controller 301 proceeds to step S85. In step S84, the controller 301 displays the next page, and returns to step S83. In step S85, the controller 301 determines whether automatic determination has been selected. When determining that automatic determination has been selected (step S85; Y), the controller 301 proceeds to step S86. When determining that automatic determination has not been selected (step S85; N), the controller 301 continues step S85. In step S86, the controller 301 automatically selects an NG area based on the read image included in the present page and the correct image corresponding to the read image, and proceeds to step S87. In step S87, the controller 301 automatically selects the type of defect based on the read image included in the selected area and the correct image corresponding to the read image, and proceeds to step S88. In step S88, the controller 301 automatically changes the determination level corresponding to the type of defect, and proceeds to step S89. In step S89, the controller 301 highlights the area determined to be NG, and proceeds to step S90. In step S90, the controller 301 determines whether the current page is the last page. When determining that the current page is the last page (step S90; Y), the controller 301 ends the secondary inspection NG mode process. When determining that the current page is not the last page (step S90; N), the controller 301 returns to step S83.

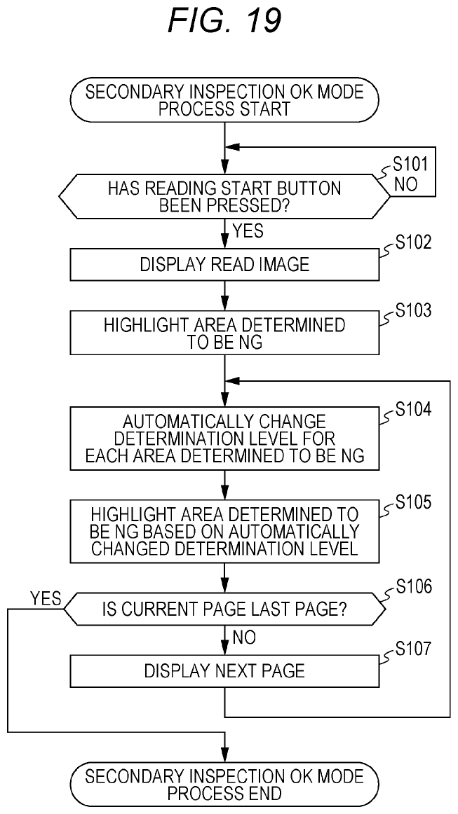

FIG. 19 is a flowchart illustrating a third modification of the secondary inspection OK mode process according to an embodiment of the present disclosure. FIG. 19 is a process of automatically determining determination levels based on all NG areas without causing the user to select areas. Note that steps S101 and S102 are respectively the same as steps S21 and S22, and a description thereof will be omitted. In step S103, the controller 301 highlights an area determined to be NG, and proceeds to step S104. In step S104, the controller 301 automatically changes the determination level for each area determined to be NG, and proceeds to step S105. In step S105, the controller 301 highlights the area determined to be NG based on the automatically changed determination level, and proceeds to step S106. In step S106, the controller 301 determines whether the current page is the last page. When determining that the current page is the last page (step S106; Y), the controller 301 ends the secondary inspection OK mode process. When determining that the current page is not the last page (step S106; N), the controller 301 proceeds to step S107. In step S107, the controller 301 displays the next page, and returns to step S104.

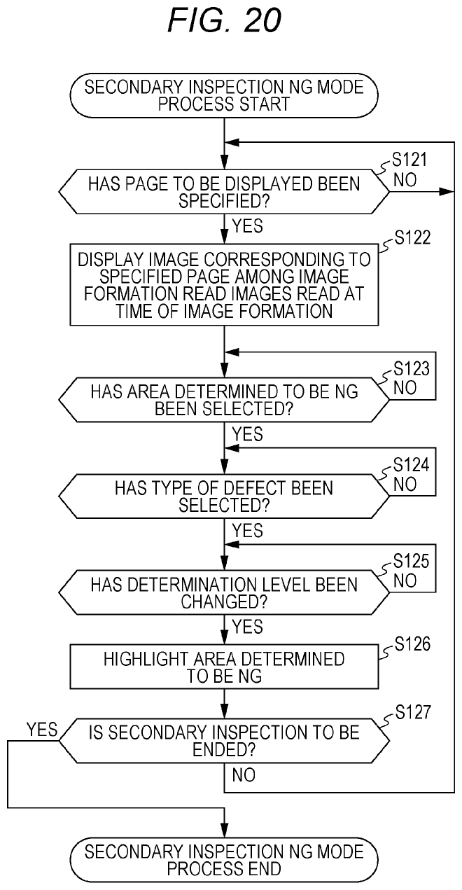

FIG. 20 is a flowchart illustrating a fourth modification of the secondary inspection NG mode process according to an embodiment of the present disclosure. FIG. 20 is a process of displaying a page specified by the user from the read images read at the time of primary inspection, instead of causing the image reading device 5 to read the image of the sheet P1 at the time of secondary inspection. In step S121, the controller 301 determines whether the page to be displayed has been specified. When determining that the page to be displayed has been specified (step S121; Y), the controller 301 proceeds to step S122. When determining that the page to be displayed has not been specified (step S121; N), the controller 301 continues step S121. In step S122, the controller 301 displays the image corresponding to the specified page among the image formation read images read at the time of image formation, and proceeds to step S123. In step S123, the controller 301 determines whether an area determined to be NG has been selected. When determining that an area determined to be NG has been selected (step S123; Y), the controller 301 proceeds to step S124. When determining that an area determined to be NG has not been selected (step S123; N), the controller 301 continues step S123. In step S124, the controller 301 determines whether the type of defect has been selected. When determining that the type of defect has been selected (step S124; Y), the controller 301 proceeds to step S125. When determining that the type of defect has not been selected (step S124; N), the controller 301 continues step S124. In step S125, the controller 301 determines whether the determination level has been changed. When determining that the determination level has been changed (step S125; Y), the controller 301 proceeds to step S126. When determining that the determination level has not been changed (step S125; N), the controller 301 continues step S125. In step S126, the controller 301 highlights the area determined to be NG, and proceeds to step S127. In step S127, the controller 301 determines whether to end the secondary inspection. When determining to end the secondary inspection (step S127; Y), the controller 301 ends the secondary inspection NG mode process. When determining not to end the secondary inspection (step S127; N), the controller 301 returns to step S121.

It should be noted that, if a determination criterion is changed, the changed determination criterion is applied to all subsequent jobs, but the following modifications are possible. For example, after a determination criterion is changed for a print job in accordance with the secondary inspection result, the changed determination criterion is applied to subsequent similar print jobs. That is, the determination criterion can be identified by a job. Alternatively, for example, after a determination criterion is changed for a specific page in accordance with the secondary inspection result, the changed determination criterion is applied to the specific page of subsequent predetermined print jobs. That is, the determination criterion can be identified by a job and a page. Still alternatively, for example, after a determination criterion is changed for a designated area in accordance with the secondary inspection result, the changed determination criterion is applied to the designated area of subsequent predetermined print jobs. That is, the determination criterion can be identified by a job and an area.

The above description shows, in the present embodiment, that the image forming apparatus 1 includes: the image forming apparatus main body 3 that forms an image on the sheet P1; the image reading device 5 provided downstream of the image forming apparatus main body 3 to read an image formed on the sheet P1 by the image forming apparatus main body 3; and the controller 301 that controls the image forming apparatus main body 3 and the image reading device 5, and the controller 301 changes, in accordance with a secondary inspection result of secondary inspection in which a user performs visual check, a determination criterion for primary inspection of a read image that is a result of reading an image by the image reading device 5. Therefore, the primary inspection result of primary inspection is changed in accordance with the secondary inspection result of secondary inspection. Thus, the image forming apparatus 1 can receive feedback on an appropriate determination criterion for subsequent print jobs even when determinations differ between primary inspection and secondary inspection.

The present embodiment further includes the setter 36 that receives an operation instruction from the user, and in response to the setter 36 receiving an operation instruction indicating that a primary inspection result of the primary inspection has been determined to be normal and the secondary inspection result has been determined to be abnormal, the controller 301 adjusts the determination criterion to the secondary inspection result. Therefore, even though the normality determined as the primary inspection result is wrong, the determination criterion can be adjusted to reflect the abnormality determined as the secondary inspection result. Thus, a remedy for erroneous determination can be executed.

In the present embodiment, in response to the setter 36 receiving an operation instruction indicating that the primary inspection result has been determined to be abnormal and the secondary inspection result has been determined to be normal, the controller 301 adjusts the determination criterion to the secondary inspection result. Therefore, even though the abnormality determined as the primary inspection result is wrong, the determination criterion can be adjusted to reflect the normality determined as the secondary inspection result. Thus, a remedy for erroneous determination can be executed.

In the present embodiment, in accordance with a result of reading the sheet P1 subjected to the secondary inspection by the image reading device 5, the controller 301 identifies a page of the secondary inspection result from the sheet P1. Therefore, a specific page can be identified from many sheets P1. Thus, the change of the determination criterion can be efficiently executed.

The present embodiment further includes the document image scanning device 38b provided at an upper part of the image forming apparatus main body 3 to read an image formed on the sheet P1, and in accordance with a result of reading the sheet P1 subjected to the secondary inspection by the document image scanning device 38h, the controller 301 identifies a page of the secondary inspection result from the sheet P1. Therefore, while performing primary inspection on the image formed on the sheet P1 corresponding to the currently executed print job, the determination criterion can be changed in accordance with the secondary inspection result of secondary inspection on the image formed on the sheet P1 corresponding to the previously executed print job.

In the present embodiment, the controller 301 identifies the page from the sheet P1 in accordance with the operation instruction received by the setter 36. Therefore, the result of reading at the time of primary inspection can also be read.

In the present embodiment, in a case where an image formed on the sheet P1 by the image forming apparatus main body 3 is read by the image reading device 5, the controller 301 identifies the page from the sheet P1 using the document image scanning device 38b. Therefore, while performing primary inspection on the image formed on the sheet P1 corresponding to the currently executed print job, the determination criterion can be changed in accordance with the secondary inspection result of secondary inspection on the image formed on the sheet P1 corresponding to the previously executed print job.

In the present embodiment, in a case where an image formed on the sheet P1 by the image forming apparatus main body 3 is read by the image reading device 5, the controller 301 identifies the page from the sheet P1 using the setter 36. Therefore, while performing primary inspection on the image formed on the sheet P1 corresponding to the currently executed print job, the determination criterion can be changed in accordance with the secondary inspection result of secondary inspection on the image formed on the sheet P1 corresponding to the previously executed print job.

In the present embodiment, in a case where an image formed on the sheet P1 by the image forming apparatus main body 3 is not read by the image reading device 5, the controller 301 identifies the page from the sheet P1 using the image reading device 5. Therefore, an image formed on the sheet P1 can be read under conditions close to those at the time of printing. Thus, the secondary inspection result of secondary inspection can be accurately reflected.

In the present embodiment, in a case where the operation instruction received by the setter 36 indicates that a process of changing the determination criterion in accordance with the secondary inspection result is executed at a set time, the controller 301 changes the determination criterion in accordance with the secondary inspection result at the set time. Therefore, print jobs can be executed until the set time, and the process of changing the determination criterion in accordance with the secondary inspection result can be executed at the set time. Thus, the hardware resources of the image forming apparatus 1 can be effectively used.

In the present embodiment, the setter 36 receives at least one of an area corresponding to an image associated with the secondary inspection result and a type of defect. Therefore, the details of the secondary inspection result can be identified.

In the present embodiment, the setter 36 displays an area including an image determined to be abnormal in the primary inspection result in a manner different from that for an area including an image determined to be normal in the primary inspection result. Therefore, the user can be intuitively notified that determinations differ between primary inspection and secondary inspection.

In the present embodiment, the setter 36 receives a change in a determination level corresponding to the type of defect as the determination criterion. Therefore, the determination criterion can be easily changed by changing the determination level.

In the present embodiment, the setter 36 changes an area including an image determined to be normal in the primary inspection result in accordance with the change in the determination level. Therefore, even if the primary inspection result changes from normal to abnormal due to the change in the determination level, the image determined to be normal in the primary inspection result is determined again in accordance with the change in the determination level. Thus, the user can be intuitively notified of the change in the determination level.

In the present embodiment, for the read image obtained by the image reading device 5 reading an image formed on the sheet P1 by a print job received by the setter 36, the controller 301 changes the determination criterion in accordance with the secondary inspection result. Therefore, the determination criterion can be changed for each print job.

In the present embodiment, when executing the primary inspection, the controller 301 associates the print job with the determination criterion. Therefore, when the determination criterion is changed in accordance with the secondary inspection result, the determination criterion can be changed in association with the print job.

The image forming apparatus 1 according to the present disclosure has been described so far based on an embodiment, but the present disclosure is not limited thereto, and may be modified without departing from the gist of the present disclosure.

For example, in the present embodiment, the waste paper P_F is discharged to the purge tray 64, which is a non-limiting example of the present disclosure. For example, the waste paper P_F may be discharged to the main tray 74_2. Further, the sheet feed path 42 is provided in the paper inserter 4, which is also a non-limiting example of the present disclosure. The sheet feed path 42 only needs to be provided to bypass the image former 34, and may be provided inside the image forming apparatus main body 3.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming apparatus comprising:
an image forming apparatus main body that forms an image on a sheet;
an image reading device provided downstream of the image forming apparatus main body to read an image formed on the sheet by the image forming apparatus main body; and
a hardware processor that controls the image forming apparatus main body and the image reading device, wherein
the hardware processor changes, in accordance with a secondary inspection result of secondary inspection in which a user performs visual check, a determination criterion for primary inspection of a read image that is a result of reading an image by the image reading device.

2. The image forming apparatus according to claim 1, further comprising
a setter that receives an operation instruction from the user, wherein
in response to the setter receiving an operation instruction indicating that a primary inspection result of the primary inspection has been determined to be normal and the secondary inspection result has been determined to be abnormal, the hardware processor adjusts the determination criterion to the secondary inspection result.

3. The image forming apparatus according to claim 2, wherein
in response to the setter receiving an operation instruction indicating that the primary inspection result has been determined to be abnormal and the secondary inspection result has been determined to be normal, the hardware processor adjusts the determination criterion to the secondary inspection result.

4. The image forming apparatus according to claim 2, wherein
in accordance with a result of reading the sheet subjected to the secondary inspection by the image reading device, the hardware processor identifies a page of the secondary inspection result from the sheet.

5. The image forming apparatus according to claim 2, further comprising
a document image scanning device provided at an upper part of the image forming apparatus main body to read an image formed on the sheet, wherein
in accordance with a result of reading the sheet subjected to the secondary inspection by the document image scanning device, the hardware processor identifies a page of the secondary inspection result from the sheet.

6. The image forming apparatus according to claim 4, wherein
the hardware processor identifies the page from the sheet in accordance with the operation instruction received by the setter.

7. The image forming apparatus according to claim 5, wherein
in a case where an image formed on the sheet by the image forming apparatus main body is read by the image reading device, the hardware processor identifies the page from the sheet using the document image scanning device.

8. The image forming apparatus according to claim 6, wherein
in a case where an image formed on the sheet by the image forming apparatus main body is read by the image reading device, the hardware processor identifies the page from the sheet using the setter.

9. The image forming apparatus according to claim 4, wherein
in a case where an image formed on the sheet by the image forming apparatus main body is not read by the image reading device, the hardware processor identifies the page from the sheet using the image reading device.

10. The image forming apparatus according to claim 2, wherein
in a case where the operation instruction received by the setter indicates that a process of changing the determination criterion in accordance with the secondary inspection result is executed at a set time, the hardware processor changes the determination criterion in accordance with the secondary inspection result at the set time.

11. The image forming apparatus according to claim 2, wherein
the setter receives at least one of an area corresponding to an image associated with the secondary inspection result and a type of defect.

12. The image forming apparatus according to claim 11, wherein
the setter displays an area including an image determined to be abnormal in the primary inspection result in a manner different from that for an area including an image determined to be normal in the primary inspection result.

13. The image forming apparatus according to claim 11, wherein
the setter receives a change in a determination level corresponding to the type of defect as the determination criterion.

14. The image forming apparatus according to claim 13, wherein
the setter changes an area including an image determined to be normal in the primary inspection result in accordance with the change in the determination level.

15. The image forming apparatus according to claim 2, wherein
for the read image obtained by the image reading device reading an image formed on the sheet by a print job received by the setter, the hardware processor changes the determination criterion in accordance with the secondary inspection result.

16. The image forming apparatus according to claim 15, wherein
when executing the primary inspection, the hardware processor associates the print job with the determination criterion.

17. An image forming method that is executed by an image forming apparatus, the apparatus comprising:
an image forming apparatus main body that forms an image on a sheet; and
an image reading device provided downstream of the image forming apparatus main body to read an image formed on the sheet by the image forming apparatus main body, wherein
the method includes
changing, in accordance with a secondary inspection result of secondary inspection in which a user performs visual check, a determination criterion for primary inspection of a read image that is a result of reading an image by the image reading device.

18. A non-transitory recording medium storing a computer readable program for causing a computer to function as a hardware processor, the computer controlling an image forming apparatus, the apparatus comprising:
an image forming apparatus main body that forms an image on a sheet; and
an image reading device provided downstream of the image forming apparatus main body to read an image formed on the sheet by the image forming apparatus main body, wherein
the hardware processor changes, in accordance with a secondary inspection result of secondary inspection in which a user performs visual check, a determination criterion for primary inspection of a read image that is a result of reading an image by the image reading device.
